(19) United States
(12) Patent Application Publication
(10) Pub. No.: US 2014/0016255 A1
(43) Pub. Date: Jan. 16, 2014

(54) CONTAINER DATA CENTER

(71) Applicant: TAI-WEI LIN, Tu-Cheng (TW)

(72) Inventor: TAI-WEI LIN, Tu-Cheng (TW)

(73) Assignee: HON HAI PRECISION INDUSTRY CO., LTD., Tu-Cheng (TW)

(21) Appl. No.: 13/568,113

(22) Filed: Aug. 6, 2012

(30) Foreign Application Priority Data
Jul. 16, 2012 (TW) 101125522

(51) Int. Cl. G06F 1/20

(52) U.S. Cl. 361/679.5; 361/679.49

(57) ABSTRACT

A container data center includes a container, a number of rack servers arranged in the container, and a cooling room. Each rack server includes a fan module attached to a first side of the rack server, and defines an opening in a second side of the rack server facing the cooling room. The fan module operates to draw air from the rack server, then the cool air in the cooling room flows into the rack server to cool the rack server.

### BACKGROUND

1. Technical Field

The present disclosure relates to a container data center.

2. Description of Related Art

With increasing use of online applications, the need for computer data centers has increased rapidly. Data centers are centralized computing facilities that include many rack servers. During operation, server systems generate a great amount of heat in the data centers. A common method for dissipating the heat is to define a cooling room, which is cooled by an air-conditioning device. The cooling room cools the rack servers by air conditioners and fans, which cannot supply different cooling airflow according to the different needs of the rack servers.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of a container data center, according to an exemplary embodiment, wherein the container data center includes a rack server.

FIG. 2 is an enlarged view of the rack server of FIG. 1.

FIG. 3 is a partial, block diagram view of the container data center of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

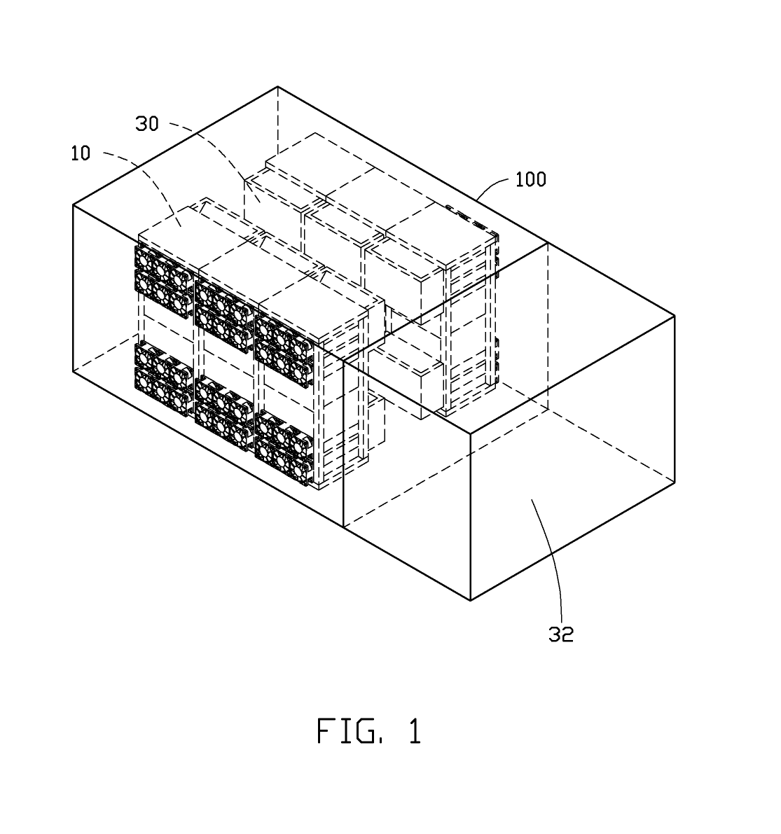

Referring to FIG. 1, an embodiment of a container data center includes a container 100 and two rows of rack servers 10 arranged in the container 100.

The container 100 includes a cooling room 30 and an air-conditioning device 32 for cooling the cooling room 30. The cooling room 30 is located between the rows of rack servers 10.

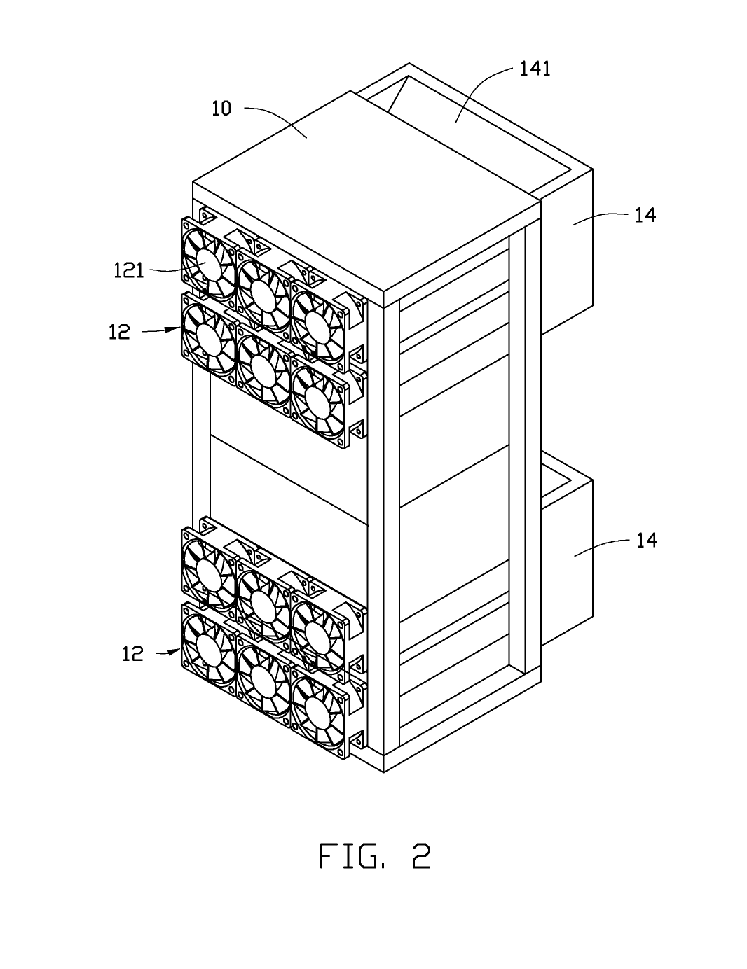

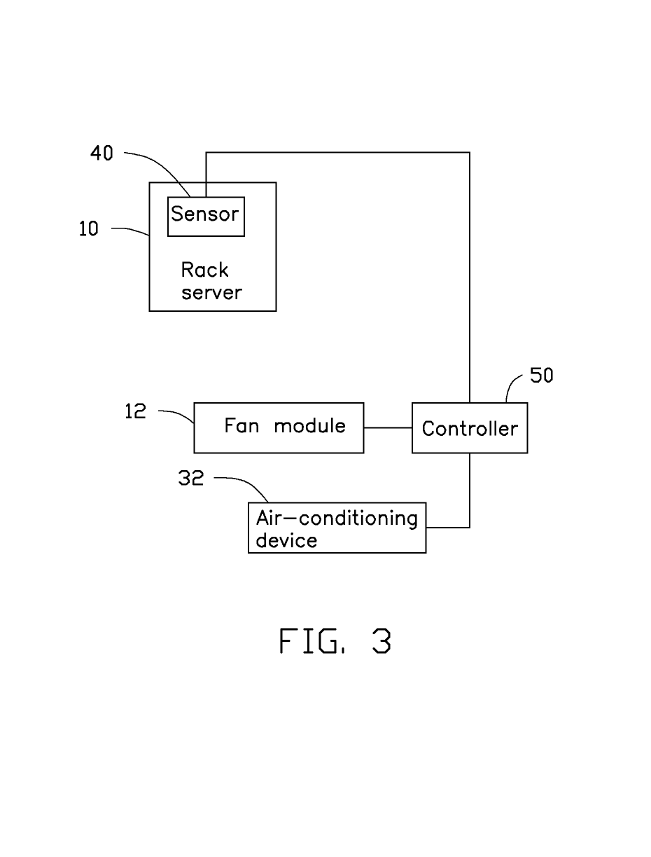

Referring to FIG. 2, each rack server 10 includes two fan modules 12 respectively attached to an up portion and a lower portion of a first side of the rack server 10 opposite to the cooling room 30. Each fan module 12 includes a plurality of fans 121. Two boxes 14 are mounted to an up portion and a lower portion of a second side of the rack server 10 facing the cooling room 30. Each of the boxes 14 defines an opening 141 opposite to the other box 14. A sensor 40 (shown in FIG. 3) is arranged in each rack server 10.

Referring to FIG. 3, when the rack servers 10 operate, the fan modules 12 operate to exhaust hot air from the rack servers 10. The rack servers 10 then become negative pressure rooms to let the cooling air in the cooling room 30 enter the rack servers 10 through the openings 141. The sensors 40 sense the temperature in the rack servers 10 and transmit the temperature signals to a controller 50. When the controller 50 receives a high temperature signal, the controller 50 will speed up the fan modules 12 of the rack server 10, to let more cooling air of the cooling room 30 to enter the rack server 10. When the temperature in the rack servers 10 is too high and the fan modules 12 as already operate at a fastest speed, the controller 50 will control the air-conditioning device 32 to lower the temperature of the cooling room 30.

In other embodiments, the fan modules 12 may be arranged at a different position according to the different positions of the server modules in the rack server 10.

In the embodiment, the fan modules 12 are mounted on one side of the rack servers 10 to exhaust hot air from the rack servers 10. The rack servers 10 then become negative pressure rooms to let the cooling air in the cooling room 30 enter the rack servers 10 to cool the rack servers 10. The speed of the fan modules 12 can be adjusted to adjust the cooling airflow flowing into the rack servers 10, which can supply different cooling airflow according to the different needs of the rack servers 10.

Even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A container data center, comprising:
a container;
a cooling room defined in the container; and
a rack server arranged in the container and beside the cooling room;
wherein the rack server comprises a fan module attached to a first side of the rack server, to exhaust hot air from the rack server, and an opening defined in a second side of the rack server facing the cooling room, the rack server becomes a negative pressure room in response to the fan module operating, to let cooling air in the cooling room to enter the rack server.

2. The container data center of claim 1, further comprising an air-conditioning device for cooling the cooling room.

3. The container data center of claim 1, wherein the fan module comprises a plurality of fans.

4. The container data center of claim 1, wherein a box is attached to the second side of the rack server, the opening is defined in a top of the box.

5. The container data center of claim 1, wherein a sensor is arranged in the rack server, the sensor senses the temperature in the rack server and transmits temperature signals about the sensed temperature to a controller, the controller controls the speed of the fan module.

6. A container data center, comprising:
a container;
a cooling room defined in the container; and
a plurality of rack servers arranged in the container and beside the cooling room;
wherein each of the rack servers comprises two fan modules respectively attached to an upper portion and a lower portion of a first side of the rack server, and defines two openings respectively in an upper portion and a lower portion of a second side of the rack server facing the cooling room, the fan modules operate to exhaust from the rack servers, the rack servers become negative pressure rooms to let cooling air in the cooling room to enter the rack servers.

7. The container data center of claim 6, further comprising an air-conditioning device for cooling the cooling room.

8. The container data center of claim 6, wherein each fan module comprises a plurality of fans.

9. The container data center of claim 6, wherein a sensor is arranged in each of the rack servers, the sensors sense the temperature in the rack servers and transmit temperature signals about the sensed temperature to a controller, the controller controls the speeds of the fan modules.
